(19) United States
(12) Patent Application Publication
(10) Pub. No.: US 2006/0042107 A1
(43) Pub. Date: Mar. 2, 2006

(54) Magnetic location device

(76) Inventor: Viatcheslav Ligai, Austin, TX (US)

Correspondence Address: Viatcheslav (SLAV) Ligai, 11601 Tanglebriar Trail, Austin, TX, 78750, US

(21) Appl. No.: 10/928,603

(22) Filed: Aug. 27, 2004

(51) Int. Cl. G01C 17/00

(52) U.S. Cl. 33/352

(57) ABSTRACT

A magnetic location device comprising a housing having a distal end, a rotatable first visual element contained within said housing, a magnetic second visual element contained within said housing, said first visual element and said second visual element being capable of at least one matching position and yielding a suggested direction of travel.

This application claims priority to Provisional Patent Application No. 60/498,104 Filed on Aug. 26, 2003.

### FIELD OF THE INVENTION

The present invention relates generally to a magnetic location device. In particular, it relates to a portable device that utilizes the earth's magnetic field in order to determine a travel direction to a desired location.

### BACKGROUND OF THE INVENTION

There have been many advances in navigation devices and location devices in particular. Through the ages, navigational devices were simple in manufacture, but difficult to use and usually required reference to a map of land, sea, or stars. In recent times, the advent of a global positioning system (GPS) has made navigation to a particular destination easier, but the cost of such systems is prohibitive for many uses. The size and complexity of such systems are not convenient to be carried as an everyday item. In order to provide a solution to common navigational problems, such as locating a person's vehicle, a convenient, low cost, portable location device is needed that operates with the earth's magnetic field.

U.S. Pat. No. 6,529,142 to Yeh et al. discloses a system for locating a vehicle. The system utilizes two signal generator and processor circuits and radio signals. The system does not utilize the earth's magnetic field and therefore is not suitable for inexpensive and portable applications.

U.S. Pat. No. 5,146,687 discloses an improved camper's compass. However, this device requires the use of a map and knowledge of compass headings.

It is needed to provide a location device that operates on the magnetic field and provides a user with a simple and easy to use method of finding a return direction.

### OBJECTS AND SUMMARY OF THE INVENTION

It is an object of the present invention to provide a navigational aid that operates with the earth's magnetic field. It is a further object of the invention to provide a portable location device that is inexpensive and portable and suitable for placement in a key fob. It is a yet another object of the invention to provide a location device that is not limited by distance or operable range. It is still a further object of the invention to provide a navigation device that is simple enough for mass market appeal.

The invention is defined by the appended claims with a specific embodiment shown in the attached drawings. For the purpose of summarizing the invention, the invention comprises a location device with a housing, a first visual element, and a second visual element, one of the visual elements is rotatable by the user and the other visual element is responsive to the earth's magnetic field.

The primary advantage of the present invention is that although the invention utilizes magnetic north in order to operate, the user is not required to know or note either direction or compass heading in using a device of the invention. Navigational calculations are eliminated and replaced with a simple visual matching or visual instruction.

In utilizing a preferred embodiment of the invention suited for locating a parked car, a user would pick out a destination of choice upon exiting a vehicle. The orientation of the magnetic second visual element is set by the earth's magnetic field. The user would then point the housing toward the destination and rotate the first visual element until it matches up with the second visual element. The user would then proceed to their destination, e.g. a shopping mall entrance.

Upon initiating the return to the vehicle from the shopping mall entrance, the user would again operate the location device to find a return path, in this example to a parked vehicle. The orientation of the first visual element relative to the housing was previously set by the user. The orientation of the second visual element is determined by the earth's magnetic field and is therefore constant. To determine the correct return direction, the user would position the housing in various directions until the second visual element matches up with the first visual element. The user would then proceed in the direction the housing is pointing towards.

In one preferred embodiment, the housing has a travel side and a return side so that the user would point the travel side of the housing in the first instance, and for determining the return direction, the user would point the return side towards the potential directions of travel. The second visual element contains part of a visual pattern or design that matches up with the visual pattern or design of the first visual element.

In another preferred embodiment, the second visual element contains two instances of a visual pattern such that either instance will match up with the visual pattern of the first visual element. In this particular embodiment, the housing distal end serves as the operable end for the travel direction and the return direction. The visual pattern of the second element will match up in two different directions separated by 180 degrees. When faced with choosing among potential directions to point the housing, the first and second visual elements would match up in an erroneous direction in the exact opposite direction of the correct direction. When a user operates the device upon exiting, for example, a shopping mall, the user would not logically point the housing towards the building entrance when searching for a parked vehicle. In this way, the device could more easily be attached to a key chain and the housing would have a single operable distal end that could be used for the travel side and return side of the trip.

In another preferred embodiment the location device housing also contains a keyless entry device known in the art. It is expected that the device of the invention could be combined with any known portable electronic device or module such as a flash light or a wireless communication device including a mobile phone.

In another preferred embodiment, the first visual element overlays a liquid filled container and the magnetic second visual element is contained within the container.

This will facilitate the movement of the magnetic element.

In another preferred embodiment, the visual elements of the invention comprise a logo.

In another preferred embodiment, the visual elements of the invention comprise a logo of a brand of vehicle.

The function of the device of the invention relies on the interaction of three parts of the device. A first element with an orientation set by the user and fixed relative to the housing. A second element with an orientation set by the earth's magnetic field. A housing which contains the other elements and can be pointed in various directions. It is a further object of the invention to use electronics to simplify and modernize the functions of the invention and provide a preferred embodiment that functions on the same principle, but produces the return direction in different ways.

A preferred electronic embodiment of the invention comprises an electronic compass, an electronic display, and a processor. The electronic display produces the first visual element and the second visual element. A display screen provides a visual pattern whereby the user aligns the first visual element with the second visual element with the use of, for example, a thumbwheel. The processor senses the movement of the thumbwheel and produces a corresponding movement of the first visual element. To determine the return direction, the processor in conjunction with the electronic compass generates the first visual element with the same position relative to the housing. The processor then produces the second visual element on the display screen in a position dictated by the electronic compass. In this way, the first and second visual elements are produced by the microprocessor and the electronic display.

In yet another preferred embodiment, the location device of the present invention does not require a rotatable element, but instead stores a position relative to compass direction in memory. In this way, the processor uses electronic memory in place of the positioning of a physical thumbwheel. This embodiment of the invention further includes a button by which the user initiates a direction of travel. The user points the housing at the desired location and pushes a button connected to the processor. Actuation of the button causes the processor to store a vector reading. To determine the return direction, the user merely pushes the button again and the processor calculates the return direction and compares the position of the housing relative to the heading information from the electronic compass. The processor then sends an advisory image to the electronic display. The image can be an arrow pointing to the left or right of the housing or any other indicia helpful to the user. Pointing the housing in the correct direction results in a positive advisory image. Optionally, pointing the housing in the correct direction can be accompanied by a beep or other audible signal.

In another preferred embodiment of the invention, the electronic display is a liquid crystal display (LCD). An LCD screen can produce any of a number of visual images such that the location device is customizable to particular applications and user preferences.

In still another preferred embodiment of the invention, the second magnetic visual element is composed of a microprocessor, digital compass, and electronic display. The first rotatable visual element is positioned by the user when determining the travel direction. In determining the return direction, the processor produces a direction indicator to assist the user in finding the correct return direction. For instance, the processor compares the position of the first rotatable visual element with a signal from the digital compass. The processor then sends a signal to the electronic display which generates a directional arrow based on the movement of the housing needed to close the distance between the current visual element spacing and a visual element position that is matching.

In another preferred embodiment, the electronic display is a LCD screen indicating, e.g. whether the user should point the housing more to the right, or more to the left. The processor and LCD screen generate a straight ahead arrow when the first and second elements are matching.

In a still further embodiment of the invention, a microprocessor is connected to a plurality of LEDs located on the distal end of the housing. The microprocessor calculates a return direction based on the compass output relative to the housing position. The microprocessor then lights the LED corresponding to the correct return direction. Rotational movement of the housing changes the compass output relative to the housing position, and again the microprocessor lights the corresponding LED. Optionally, the LED corresponding to a return direction along the length of the housing is a different color, for example green whereas the other LEDs are red.

In yet another preferred embodiment of the invention, a LCD is used to block the transfer of light through the first visual element. The microprocessor can alter the transmissivity of the LCD to provide a visual indication of the correct matching rotational alignment of the housing and the electronic compass. This embodiment will therefore block the user's view of the second visual element or the bottom of the housing until the correct rotational alignment is achieved. The LCD can then be altered to show an image or signal that indicates the correct direction has been achieved.

Many combinations of the above features can be utilized by one skilled in the art to practice the present invention. These embodiments are illustrative and do not limit the scope of the claims.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is an exploded view of an embodiment of the invention.

FIG. 2 is an exploded see-through view of an embodiment of the invention.

FIG. 3 is a view of a preferred embodiment of the invention including a keyless entry transmitter.

FIG. 4 is a schematic of the processing algorithm of an embodiment of the present invention.

FIG. 5 is a schematic of an embodiment of the present invention including a processor.

### DETAILED DESCRIPTION OF THE DRAWINGS

The present invention is described with reference to the enclosed figures. In a broad embodiment, the invention comprises a location device with a housing, a first visual element, and a second visual element, one of the visual elements is rotatable by the user and the other visual element is responsive to the earth's magnetic field.

The primary advantage of the present invention is that although the invention utilizes magnetic north in order to operate, the user is not required to know or note either direction or compass heading in using a device of the invention. Navigational calculations are eliminated and replaced with a simple visual matching or visual instruction.

In utilizing a preferred embodiment of the invention suited for locating a parked car, a user would pick out a destination of choice upon exiting a vehicle. The orientation of the magnetic second visual element is set by the earth's magnetic field. The user would then point the housing toward the destination and rotate the first visual element until it matches up with the second visual element. The user would then proceed to their destination, e.g. a shopping mall entrance.

Upon initiating the return to the vehicle from the shopping mall entrance, the user would again operate the location device to find a return path, in this example to a parked vehicle. The orientation of the first visual element relative to the housing was previously set by the user. The orientation of the second visual element is determined by the earth's magnetic field and is therefore constant. To determine the correct return direction, the user would position the housing in various directions until the second visual element matches up with the first visual element. The user would then proceed in the direction the housing is pointing towards.

A preferred electronic embodiment of the invention comprises an electronic compass, an electronic display, and a microprocessor. The electronic display produces the first visual element and the second visual element. A display screen provides a visual pattern whereby the user aligns the first visual element with the second visual element with the use of, for example, a thumbwheel. The processor senses the movement of the thumbwheel and produces a corresponding movement of the first visual element. To determine the return direction, the processor in conjunction with the electronic compass generates the first visual element with the same position relative to the housing. The processor then produces the second visual element on the display screen in a position dictated by the electronic compass. In this way, the first and second visual elements are produced by the microprocessor and the electronic display.

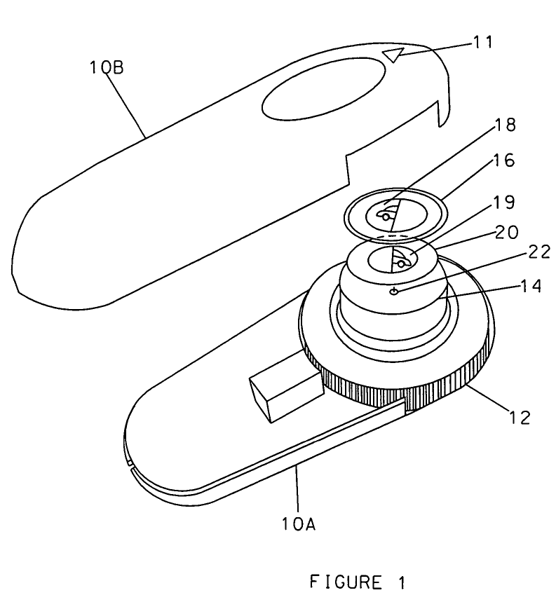

Referring now to specific elements, FIG. 1 presents a view of an embodiment of the invention. Housing bottom 10A contains ring shaped thumbwheel 12 which is rotatable within the housing. Cylinder 14 is mounted on the thumbwheel and supports circular first visual element 16. The visual element 16 is connected to the cylinder 14 and thereby connected to the thumbwheel 12 and is rotated by the user using thumbwheel 12. Visual element 16 has a visual design 18 or pattern formed in the element, or painted, drawn, or attached by adhesive, e.g. a sticker to visual element 16.

The magnetic second visual element 20 is supported by a pin 22 attached to the housing bottom 10A within hollow cylinder 14. Magnetic second visual element 20 has a visual design or pattern that allows it to be matched up with the visual element 16 in at least one and preferably two matching rotational alignments. Magnetic second visual element 20 is responsive to the earth's magnetic field and continually aligns itself to the polarity of the earth's magnetic field. Housing top 10B attaches to housing bottom 10A to secure the other elements of the invention. Direction indicator 11 assists the user in establishing a travel direction and a return direction.

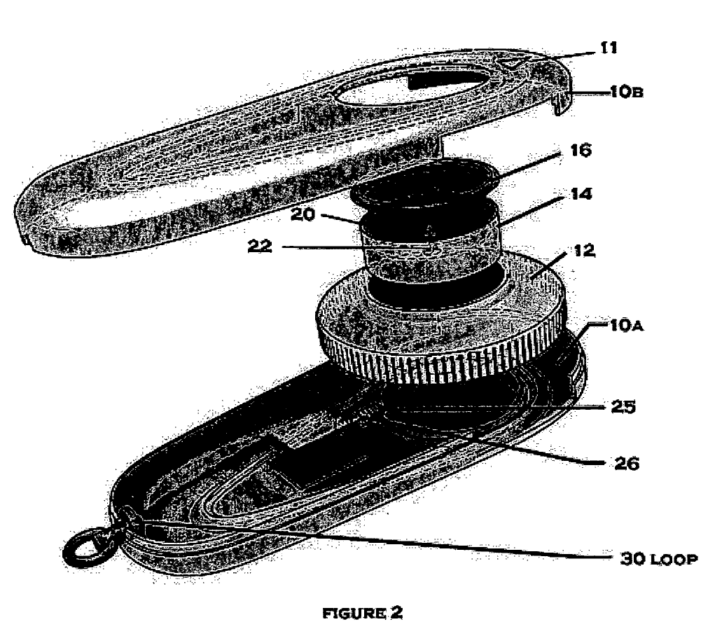

FIG. 2 presents a view of another preferred embodiment of the invention. Housing bottom 10A contains a spring 26 to provide a force to ball 25 and bias ball 25 towards thumbwheel 12. Thumbwheel 12 is therefore prevented from freely rotating.

Additionally, the ball 25 and thumbwheel 12 interaction produces an audible click when the thumbwheel is rotated. Housing top 10B is suited for connection with housing bottom 10A and the two parts of the housing secure the contents of housing. Direction indicator 11 is located on the distal end of housing top 10B. Housing bottom 10A contains thumbwheel 12 which is rotatable within the housing. Cylinder 14 is mounted on the thumbwheel and supports circular visual element 16. First visual element 16 is connected to the cylinder 14 and is rotated by the user using thumbwheel 12. Visual element 16 has a visual design or pattern (not shown) formed in the element, or painted, drawn, or attached by adhesive, e.g. a sticker to visual element 16.

The magnetic second visual element 20 is contained within cylinder 14 and below visual element 16. At least a portion of visual element 16 is see-through and enables the user to see the orientation of second visual element 20. Visual element 20 is supported by a pin 22 attached to the housing 10 within the center of thumbwheel 12. Visual element 20 has a visual design or pattern that allows it to be matched up with the visual element 16 in at least one and preferably two matching rotational alignments. Magnetic second visual element 20 is responsive to the earth's magnetic field and orients itself in a consistent alignment relative to the earth's magnetic field.

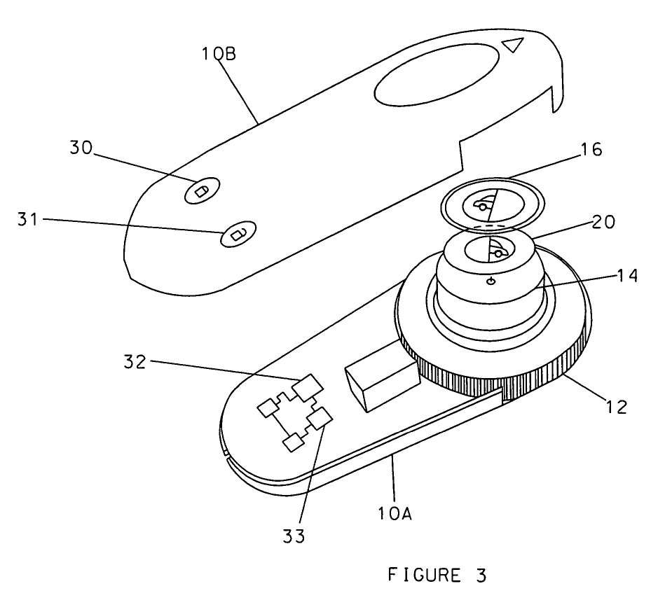

FIG. 3 presents a view of the housing of the present invention that further contains a keyless entry device. In this embodiment, the housing is a key fob. Locking button 30 and unlocking button 31 are connected to a transmitter 32 which is additionally connected to a battery 33.

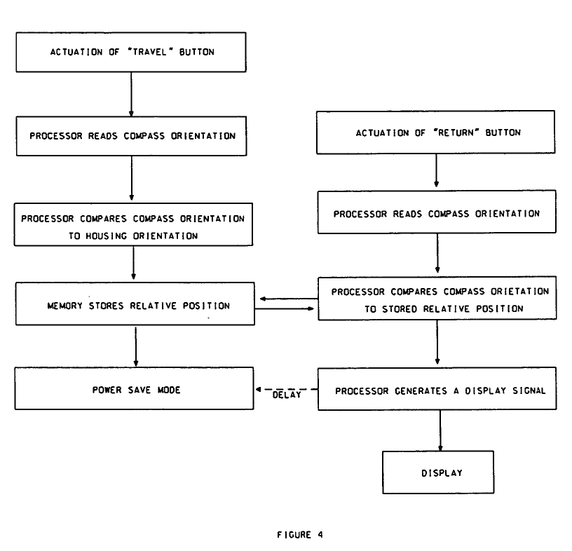

FIG. 4 presents a control chart for an electronic embodiment of the invention.

In this preferred embodiment of the present invention, the user actuates the travel button by pressing a button disposed on the housing. This causes the processor to read a compass orientation and to compare the compass orientation to the housing orientation to generate a relative position. The processor then stores the relative position in memory. The processor will either flash or beep or signal to the user that the position has been stored. The processor will then go into a power save mode. Upon actuation of the return button, the processor again reads the compass orientation. The processor compares the compass orientation to the housing orientation to generate a second relative position. The processor then compares the second relative position to the stored position. Based on the difference in these two positions, the processor then generates a display signal and transmits the signal to the display.

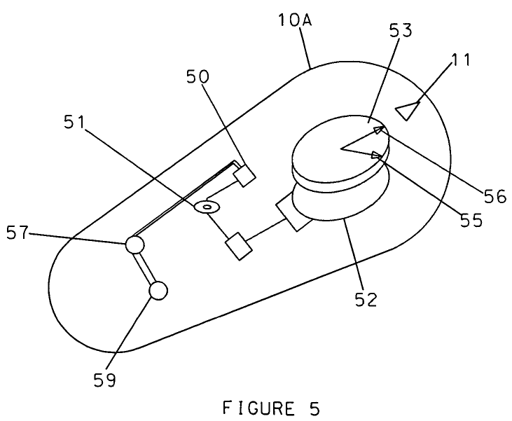

FIG. 5 presents a layout of an electronic embodiment of the invention. Electronic compass 53 is connected in circuit with a processor 50 and battery 51 and contained in housing bottom 10A. To initiate a first direction of travel, the user points the distal end of the housing with direction indicator 11 towards the destination. The user then presses travel button 57 that when activated causes processor 50 to compare and store the orientation of electronic compass 52. The processor then enters a power save mode. To determine the correct return direction, the user presses return button 59. Actuation of return button 59 causes processor 50 to compare orientation of electronic compass 52 with the stored first orientation. Processor 50 calculates a return direction 180 degrees opposite the first travel direction and based on an orientation of the electronic compass, transmits a display signal to electronic display LCD 53. LCD 53 is capable of displaying many characters and figures; directional arrows 55 and 56 are shown. If the return direction is determined to be to the right of direction indicator 11, e.g., directional arrow 55 is displayed. When the user rotates the housing 10 to the right, the processor 50 computes the output signal again and produces a display signal to display directional arrow 56. The processor produces the display signal for a set period of time, for example, one minute and then enters a power-saving or sleep mode.

1. A magnetic location device comprising:
A housing having a distal end,
a rotatable first visual element contained within said housing, a magnetic second visual element contained within said housing, said first visual element and said second visual element being capable of at least one matching position and yielding a suggested direction of travel.

2. A magnetic location device as in claim 1 wherein said direction of travel is aligned with said distal end.

3. A magnetic location device as in claim 1 wherein said second magnetic visual element is disc shaped and supported by a pin attached to said housing.

4. A magnetic location device as in claim 1 wherein said first visual element is round and mounted on a cylinder, said cylinder being mounted on a thumbwheel, said thumbwheel being contained within said housing and being rotatable to a desired orientation by a user, and said cylinder is hollow and suited to surround said second magnetic visual element.

5. A magnetic location device as in claim 4 wherein said cylinder is liquid filled and said cylinder contains said second magnetic visual element.

6. A magnetic location device as in claim 1 wherein said housing also comprises a keyless entry device.

7. A magnetic location device as in claim 1 wherein said housing also comprises attachment means for attachment to a ring.

8. A magnetic location device as in claim 1 wherein said first visual element and said second visual element comprise portions of an image and alignment of said first visual element and said second visual element completes said image.

9. A magnetic location device as in claim 8 wherein said image is a logo of a brand of vehicle.

10. A magnetic location device comprising:
A housing, an electronic compass, a battery, a processor capable of sensing a first heading signal of said electronic compass relative to said housing and storing said first heading signal; said processor upon request capable of sensing a second heading signal of said electronic compass relative to said housing, calculating a difference between said first heading signal and said second heading signal, and producing an output signal relative to said difference.

11. A magnetic location device as in claim 10 further comprising an actuation button that when activated by a user causes said processor to store said first heading signal.

12. A magnetic location device as in claim 10 further comprising an electronic display capable of displaying a suggested direction indicator based on said output signal.

13. A magnetic location device as in claim 12 wherein said electronic display is a liquid crystal display.

14. A magnetic location device as in claim 11 wherein said actuation button when activated by a user causes said processor to store said first heading signal, and when activated by a user a second time causes said processor to produce said output signal.

15. A magnetic location device as in claim 14 further comprising a plurality of LEDs disposed about a distal end of said housing, and said processor illuminating one of said plurality of LEDs based on the output signal of said processor where rotating the housing in the direction of the illuminated LED causes a decrease in said difference between said first orientation and said second orientation; said processor updating said output signal for a desired finite duration.

16. A magnetic location device as in claim 14 further comprising an electronic display wherein said processor produces a suggested direction of return travel on said electronic display in the form of an arrow pointing in said suggested direction of return travel; said suggested direction of travel being calculated as a direction that produces a heading signal approximately opposite said first heading signal.

17. A magnetic location device as in claim 1 wherein said magnetic second visual element comprises an electronic compass and an electronic display; said electronic compass senses the magnetic field of the earth and generates an image on said electronic display corresponding to the orientation of the housing relative to the earth's magnetic field.
